(19) United States
(12) Patent Application Publication
(10) Pub. No.: US 2006/0023077 A1
(43) Pub. Date: Feb. 2, 2006

(54) System and method for photo editing

(75) Inventors: Benjamin N. Alton, Seattle, WA (US); Mark D. MacKenzie, Seattle, WA (US); Xinli Zou, Beijing (CN)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/902,371

(22) Filed: Jul. 30, 2004

(51) Int. Cl. H04N 5/228

(52) U.S. Cl. 348/222.1

(57) ABSTRACT

A method and system are provided for facilitating editing of a captured photograph using a set of user interface photo interaction tools. The method includes receiving a user selection of an editing function, which may be a cropping function, through the user interface photo interaction tools. The method additionally includes determining an optimal edited photograph based on the input editing function and presenting the edited photograph on the user interface in order to allow user interaction with the edited photograph through the user interface photo interaction tools. The user interface may receive commands through a remote control device.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for editing a photograph. More particularly, embodiments of the invention relate to a technique for cropping a photo using a remote control device.

### BACKGROUND OF THE INVENTION

Computer software for editing captured photographs has become widely used. Many users download photographs from a digital camera to a personal computer and execute photo editing software routines in order to improve the photographs. Such photograph editing software routines typically require a user to enter information using a keyboard or mouse.

Home computing use has expanded beyond the traditional personal computing system and now encompasses a range of multimedia products. For instance, Windows XP Media Center Edition, produced by the Microsoft Corporation of Redmond, Wash. provides multiple entertainment and computing functions in a single system. Multi-functionality of the multimedia system enables a user to browse the Internet, communicate with other users, play games, watch movies, view photographs, watch television, etc. Windows XP Media Center Edition applications enable viewing of live and recorded television and home videos and editing of digital photographs. Furthermore, the system may be operated using a remote control device, thus enabling a user to operate the system from anywhere in the room.

The capability to operate the multimedia system remotely requires tailored interaction between a user interface and remote control device. Because a remote control device does not include all of the functionality of a keyboard and cannot point to items on the user interface in the manner of a mouse or other pointing device, specialized interaction between the remote control device and the user interface is often required. Although remote control devices are frequently used for operating a television, CD, or DVD players, a solution is needed that will also operate in conjunction with such functions as editing of digital photographs.

In digital photography applications, some commonly performed corrections include contrast and redeye corrections. Cropping is also one of the most commonly performed editing tasks. Generally, a user is required to perform a plurality of steps in order to crop an image or perform other photograph editing tasks. Accordingly, a solution is needed for utilizing a typical remote control device to obtain a cropped image with a minimal number of steps.

### BRIEF SUMMARY OF THE INVENTION

Embodiments of the present invention are directed to a method for facilitating editing of a captured photograph using a set of user interface photo interaction tools. The method includes receiving a user selection of an editing function through the user interface photo interaction tools. The method additionally includes determining an optimal edited photograph based on a requested editing function and presenting the edited photograph on the user interface in order to allow user interaction with the edited photograph through the user interface photo interaction tools.

In an additional aspect of the invention, a method is provided for facilitating cropping of a captured photograph. The method includes receiving a user request to crop the captured image and suggesting an optimal crop configuration. The method additionally includes receiving user input for accepting and editing the suggested crop configuration.

In yet a further aspect of the invention, a method is provided for facilitating user interaction with a suggested cropped photograph. The method includes providing a set of user interface photo interaction tools for interacting with the suggested cropped photograph and receiving at least one instruction from a remote control device in order to activate the photo interaction tools to interact with the suggested cropped photograph.

In an additional aspect of the invention, a system is provided for facilitating cropping of a captured photograph. The system includes a photo analysis engine for determining an optimal crop configuration and a photo presentation engine for presenting the determined optimal crop configuration on a user interface. The system additionally includes user interface photo interaction tools for allowing a user to accept the determined optimal crop configuration.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is a block diagram illustrating a computerized environment in which embodiments of the invention may be implemented;

FIG. 3 is a flow chart illustrating a method for remotely cropping a photograph in accordance with an embodiment of the invention;

FIG. 4 is a screen shot illustrating a user interface for remote photograph editing in accordance with an embodiment of the invention;

FIG. 5 is a diagram illustrating a zoom function for cropping a photograph in accordance with an embodiment of the invention; and

FIGS. 6A and 6B are diagrams illustrating a flipping technique for flipping a cropped photograph in accordance with an embodiment of the invention.

### DETAILED DESCRIPTION OF THE INVENTION

I. System Overview

Embodiments of the invention include a method and system for remotely editing a photograph using a simple remote control device and user interface. Although the system and method are described below in conjunction with a cropping application, it may be possible to implement techniques of the invention in conjunction with additional photograph editing operations.

The method and system enable cropping of photographic content using a distance user interface (UI) and a remote control device. As will be further described below, the system includes an algorithm for intelligently suggesting a crop of an image. The intelligent suggestion may be used in conjunction with a remote control device and distance UI interface to enable a user to accept or manually adjust the crop suggestion.

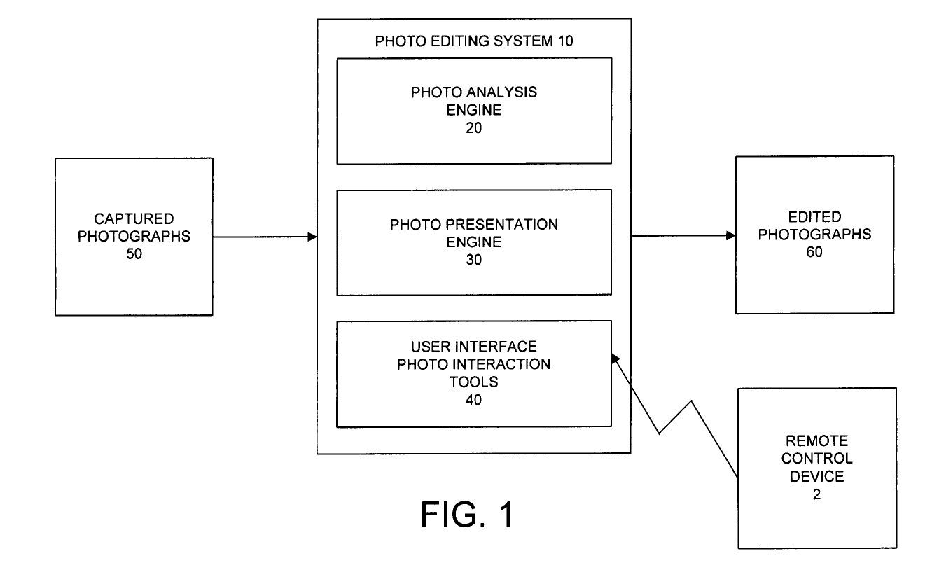

FIG. 1 illustrates a photograph editing system in accordance with an embodiment of the invention. A photo editing system 10 may include a photo analysis engine 20, a photo presentation engine 30, and a user interface photo interaction tools 40. A remote control device 2 may communicate with the photo editing system 10 in order to edit captured photographs 50 and create edited photographs 60.

The photo analysis engine 20 analyzes the captured photographs 50 in order to determine an optimal presentation. For example, the photo analysis engine 20 may determine an optimal crop for a captured photo. In order to determine the optimal crop configuration, the photo analysis engine 20 uses an existing algorithm to determine a center of attention or primary focus of a captured photograph. Based on the primary focus, the photo analysis engine 20 determines an optimal cropping suggestion. The suggestion is the “best” suggested rectangle with the aspect ratio maintained or inverted. As an example, if a photograph is 560×420 pixels, the suggested rectangle has an aspect ratio of approximately 4:3 or 3:4. No restrictions are imposed on the edges of the rectangle. Edges of the suggested rectangle may align with one, some, or none of the edges of the original image. Any suitable algorithm for finding the optimal crop configuration may be implemented in the context of the invention.

In response to the determination of the photo analysis engine 20, the photo presentation engine 30 presents the optimal crop configuration to the user. Accordingly, when the user first selects the crop function, the user is visually presented with an initial crop suggestion determined by the photo analysis engine 20. By implementing the remote control device 2 and the user interface photo interaction tools 40, the user can accept the suggested configuration or edit the suggested configuration to achieve a crop configuration desired by the user.

II. Exemplary Operating Environment

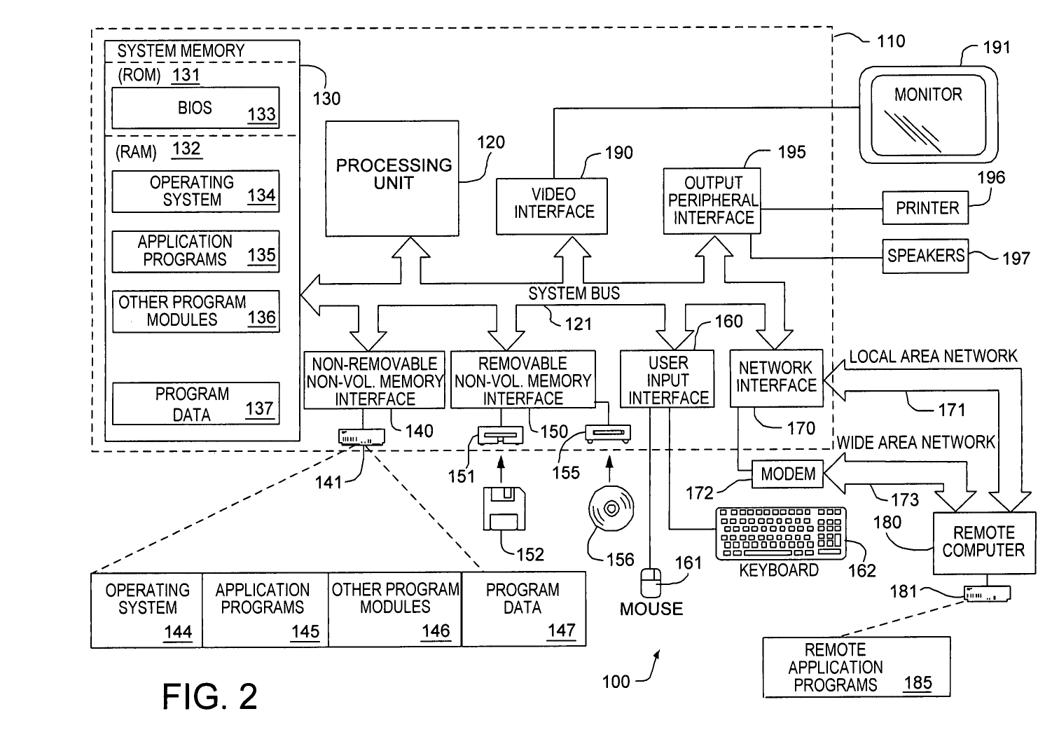

FIG. 2 illustrates an example of a suitable computing system environment 100 in which the photo editing system 10 may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a system for photo editing in accordance with an embodiment of the invention. Using the remote control device 2 and the photo editing system 10, the user is able to alter captured photographs 50, which are stored in a storage device as described above in connection with FIG. 2, in order to created edited photographs 60. The edited photographs 60 may also be stored in a storage device as described above in conjunction with FIG. 2.

The photo analysis engine 20 contained within the photo editing system 10 operates on each captured photograph 50 selected by the user in order to determine an optimal configuration as described above. The photo presentation engine 30 presents the optimal configuration and the user can activate the remote control device 2 and the user interface photo interaction tools 40 to interact with the suggested configuration either by accepting or editing the suggested configuration as will be further described below.

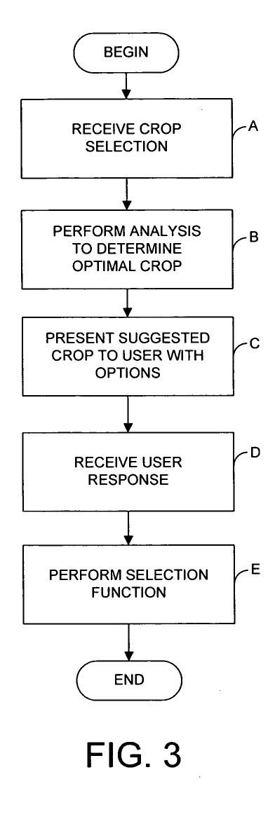

FIG. 3 illustrates a method for using the system described above in FIG. 1 to crop a photograph. In step A, the system 10 receives a crop selection from the user. Although the user interface photo interaction tools 40 may allow a number of photo editing functions, in this instance, the user selects a cropping function. In step B, the photo analysis engine 20 analyzes the photograph in order to determine an optimal crop configuration. In step C, the photo presentation engine 30 presents the optimal crop configuration as determined by the photo analysis engine 20 and the user interface photo interaction tools 40 present options for the user to interact with the suggested crop configuration either by editing or accepting the suggested configuration. The user responds by taking either of these actions using the remote control device 2 and the user interface photo interaction tools 40. Accordingly, in step D, the photo editing system 10 receives the user response. In step E, the photo editing system 10 performs the task selected by the user.

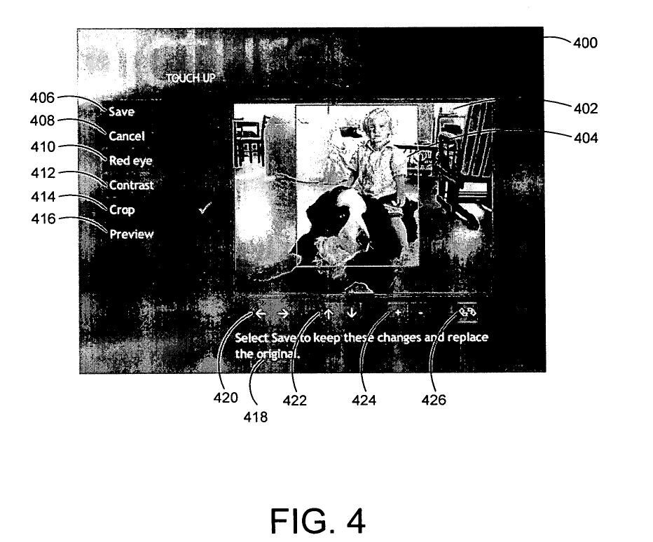

FIG. 4 illustrates a touch up screen 400 that includes user interface photo interaction tools 40. In the illustrated touch up screen 400, the user may select a save option 406, a cancel option 408, a red eye option 410, a contrast option 412, a crop option 414, and preview option 416. In the illustrated touch up screen, as indicated by the check mark beside the crop option 414, the user has selected the crop option.

In embodiments of the invention, a wait cursor will appear after the user selects the cropping option 414. The wait cursor may remain until the photo analysis engine 20 and the photo presentation engine 30 operated to present an optimal crop suggestion on the UI. Because the user has selected the crop option, the user is presented with the original image 402, and a suggested cropped version 404 of the original image 402. In embodiments of the invention, the original image 402 is shown embedded at right. The rectangle overlay 404 shows the currently presented crop and provides a strong visual cue to show what is inside and outside the rectangle 404. The cropped version 404 is determined by the system 10 using the photo analysis engine 20 and is presented to the user by the photo presentation engine 30 as described above. The check mark indicates that saving the image would result in cropping as indicated by the image cropped version 404 at right. In embodiments of the invention, if the user selects the cropping option 414 again, the checkmark is removed and the crop frame 404 is removed from the image 402.

The crop frame 404 is typically a suggested rectangle with the aspect ratio of the image 402 maintained or inverted. No restrictions are imposed on the edges of the rectangle. Edges of the suggested rectangle 404 may align with one, some, or none of the edges of the larger image 402.

A preview mode may be accessible through two methods. First, a user may select the preview option 416 on the touch up page 400 shown in FIG. 4. Secondly, the user may select the ¾ size original thumbnail 402 on the touch up page 400. For the preview option 416 to be enabled, one or more of the corrections must be applied. For instance, a checkmark must appear next to the redeye 410, contrast 412, or crop 414 options. When preview mode is selected through one of these methods, the resultant image is shown as a full screen image with the proposed changes in effect. To return to the touch up page 400, the user may use the back button on the remote.

The user is also presented with a group of editing tools. The editing tools may include horizontal adjustment tools 420, vertical adjustment tools 422, zooming tools 424, and flipping tools 426. An instructional caption 418 instructs a user to select the save option 406 in order to keep changes made by the aforementioned controls or to keep the originally presented cropped image 404.

The horizontal adjustment tools 420 include two selectable arrows, one that is capable of moving the suggested rectangle 404 to the left and another that moves the suggested rectangle 404 to the right. The vertical adjustment tools 422 also include two arrows, one that is capable of moving the presented rectangle 404 upwards on the UI and the other that moves the rectangle 404 downward within the rectangle 402. The controls 420 and 422 move only the rectangle 404 and not the visual content within the rectangle 404. Accordingly, use of the controls 420 and 422 results in a distinct cropped image with each manipulation.

If the controls 420 or 422 are utilized, the position of the rectangle 404 is moved by a discrete number of pixels. If the rectangle 404 is at the edge of the rectangle 402, a control may be disabled to prevent further movement of the rectangle 404 out of the rectangle 402. If the user causes the rectangle 404 to reach an edge of the rectangle 402, the focus jumps to the control for moving in the opposite direction. For instance, if the rectangle 404 reaches the right edge of the rectangle 402, the horizontal adjustment tool 420 for moving the rectangle 404 to the right is disabled and focus shifts to the other horizontal adjustment tool 420 for moving the rectangle 404 to the left.

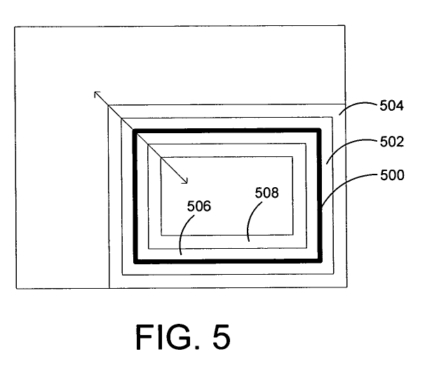

FIG. 5 illustrates operation of the zooming tools 424 illustrated in FIG. 4. As with the aforementioned controls 420, 422, the zooming controls 424 may also include two selectable options. One option creates a larger rectangle 404 and the other option creates a smaller rectangle 404. In FIG. 5, an original image 500 may be increased to the dimensions of rectangle 502 or rectangle 504. Alternatively, the size of the original image 500 may be decreased to the size of rectangle 506 or 508. If the user selects the controls 424 for zooming in, in embodiments of the invention, each dimension is decreased by a number of pixels to reduce the rectangle 404 by approximately 25%. The same center co-ordinate is maintained. The zooming tools 424 can be activated to zoom in until no further zooming in is possible. At that time, focus may move to the zoom out control. If the zoom out control is activated, in embodiments of the invention, each dimension of the rectangle 404 is increased by a number of pixels defined by increasing by approximately 25%. The same center coordinate is maintained. The zoom out function can be selected until no further zooming out is possible. When zooming out is not longer possible, the focus may automatically switch to the zoom in control.

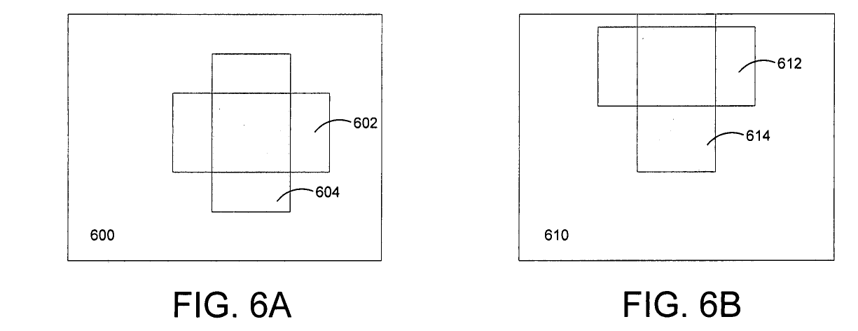

FIGS. 6A and 6B illustrate operation of the flipping tools 426 illustrated in FIG. 4. FIG. 6A illustrates an original image 600 and a cropped image 602. Using the flipping tools 426, a flipped cropped image 604 is produced. In FIG. 6B, a cropped image 612 is shown inside an original image 610. A flipped version 614 of the cropped image 612 can be created by the flipping tools 426. If the flipping function is selected, the rectangle aspect ratio is inverted while maintaining the same center coordinate. If maintaining the same center coordinate is impossible, the rectangle is flipped such that the center point moves a minimum amount. The flipping function does not always reverse itself by flipping twice in a row. Using the zooming or flipping functions, it is possible to align the rectangle 404 with two parallel edges of the image 402. In this case, both corresponding flip and zoom controls are disabled.

The remote control device 2 is implemented by the user navigating to the touch up screen 400 to activate the controls described above. The remote control device 2 preferably includes standard navigation buttons and may include an “OK”, “enter”, or “select” button to enable the user to select an option the user has reached through the navigation buttons of the remote control device 2.

If the user tries to navigate away from the touch up screen 400, a dialog may be presented to the user to inquire as to whether the user wants to save changes. The user may be required to select yes or no. If the user selects yes, the changes are saved to the file. If the user selects no, all touch up operations are reversed and changes are not saved to the file.

Accordingly, changes may be saved permanently to the file in one of two ways. Either the user may implement the save control 406 on the touch up page 400 or the user may respond yes to the dialog as set forth above. The changes must be explicitly accepted in order to be saved. Therefore, if the user, for whatever reason, does not do one of these two things, the changes may be lost and the system may revert to the original image.

The method and system provided above enable a user to navigate a UI as shown on the touch up page 400 using a remote control device 2. In embodiments of the invention, a user will be presented with a crop suggestion after selecting the crop option on the user interface with the remote control device 2. The user can also edit the crop suggestion using the remote control device 2 and the UI for the touch up screen 400.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for facilitating editing of a captured photograph using a set of user interface photo interaction tools, the method comprising:
receiving a user selection of an editing function through the user interface photo interaction tools; and
determining an optimal edited photograph based on the editing function as selected by the user; and
presenting the edited photograph on the user interface in order to allow user interaction with the edited photograph through the user interface photo interaction tools.

2. The method of claim 1, wherein receiving a user selection of an editing function comprises receiving selection of a cropping function.

3. The method of claim 2, wherein presenting the edited photograph comprises presenting a cropped version of a photograph in a small rectangle within a large rectangle representing the captured photograph.

4. The method of claim 3, wherein user interaction with the edited photograph comprises shifting the small rectangle to another location within the large rectangle.

5. The method of claim 3, wherein user interaction with the edited photograph comprises changing a size of the small rectangle within the large rectangle.

6. The method of claim 3, wherein the user interaction with the edited photograph comprises flipping the small rectangle within the large rectangle.

7. The method of claim 3, wherein user interaction with the edited photograph comprises saving the edited photograph.

8. The method of claim 3, wherein user interaction with the edited photograph comprises obtaining a full screen preview of the edited photograph.

9. The method of claim 3, further comprising allowing user interaction from a remote control device that activates the user interface photo interaction tools.

10. A computer readable medium storing computer executable instructions for performing the method of claim 1.

11. A method for facilitating cropping of a captured photograph, the method comprising:
receiving a user request to crop the captured image;
suggesting an optimal crop configuration of the captured image; and
receiving user input for one of accepting and editing the suggested crop configuration.

12. The method of claim 11, further comprising presenting the optimal crop configuration as a smaller rectangle within a larger rectangle representing the original photograph.

13. The method of claim 12, wherein receiving user input for editing the suggested crop configuration comprises receiving a user command to shift the smaller rectangle to another location within the larger rectangle.

14. The method of claim 13, further comprising receiving a user command to shift the smaller rectangle in a direction including at least of up, down, left, and right.

15. The method of claim 13, further comprising receiving a user command to change a size of the smaller rectangle with the larger rectangle.

16. The method of claim 13, further comprising receiving a user command to flip the smaller rectangle within the larger rectangle.

17. The method of claim 11, further comprising receiving a command to save the suggested crop configuration.

18. The method of claim 11, further comprising providing a full screen preview of the suggested crop configuration in response to a user request.

19. The method of claim 11, further comprising allowing user interaction from a remote control device that activates the user interface photo interaction tools.

20. A computer readable medium storing computer executable instructions for performing the method of claim 11.

21. A method for facilitating user manipulation of a suggested cropped photograph, the suggested cropped photograph presented in a smaller rectangle within a larger rectangle representing an original image, the method comprising:
providing a set of user interface photo interaction tools for manipulating the suggested cropped photograph; and
receiving at least one instruction from a remote control device in order to activate the photo interaction tools to manipulate the suggested cropped photograph.

22. The method of claim 21, wherein providing a set of user interface photo interaction tools comprises providing tools for shifting the smaller rectangle horizontally within the larger rectangle.

23. The method of claim 21, wherein providing a set of user interface photo interaction tools comprises providing tools for shifting the smaller rectangle vertically within the larger rectangle.

24. The method of claim 21, wherein providing a set of user interface photo interaction tools comprises providing tools for changing a size of the smaller rectangle within the larger rectangle.

25. The method of claim 21, wherein providing a set of user interface photo interaction tools comprises providing tools for flipping the smaller rectangle within the larger rectangle.

26. The method of claim 21, wherein providing a set of user interface photo interaction tools comprises providing tools for saving the suggested cropped photograph.

27. The method of claim 21, wherein providing a set of user interface photo interaction tools comprises providing tools for requesting a full screen preview of the suggested cropped photograph.

28. The method of claim 21, further comprising allowing user manipulation from a remote control device that activates the user interface photo interaction tools.

29. A computer readable medium storing computer executable instructions for performing the method of claim 21.

30. A system for facilitating cropping of a captured photograph, the system comprising:
a photo analysis engine for determining an optimal crop configuration;
a photo presentation engine for presenting the determined optimal crop configuration on a user interface; and
user interface photo interaction tools for allowing a user to accept the determined optimal crop configuration.

31. The system of claim 30, wherein the photo presentation engine comprises a mechanism for providing an optimal crop configuration in a smaller rectangle inside a larger rectangle representing the captured photograph.

32. The system of claim 30, wherein the user interface photo interaction tools comprise tools for allowing the user to alter the optimal crop configuration.

33. The system of claim 30, wherein the user interface photo interaction tools comprise tools for shifting the smaller rectangle within the larger rectangle.

34. The system of claim 30, wherein the user interface photo interaction tools comprise tools for changing a size of the smaller rectangle within the larger rectangle.

35. The system of claim 30, wherein the user interface photo interaction tools comprise tools for flipping the smaller rectangle within the larger rectangle.

36. The system of claim 30, wherein the user interface photo interaction tools comprise tools for saving the suggested cropped photograph.

37. The system of claim 30, wherein the user interface photo interaction tools comprise tools for providing a full screen preview of the suggested cropped photograph.

38. The system of claim 30, further comprising a remote control device that activates the user interface photo interaction tools.
